(19) United States
(12) Patent Application Publication
(10) Pub. No.: US 2016/0035559 A1
(43) Pub. Date: Feb. 4, 2016

(54) FLUORESCENT LAMP WITH INCORPORATED CHEMICAL AGENT AND METHOD THEREFOR

(71) Applicant: GENERAL ELECTRIC COMPANY, Schenectady, NY (US)

(72) Inventors: Jon Bennett Jansma, Pepper Pike, OH (US); John Matthew Root, Cleveland, OH (US); Charles Henry Kiessling, Delaware, OH (US)

(21) Appl. No.: 14/449,332

(22) Filed: Aug. 1, 2014

(51) Int. Cl. H01J 61/35; H01J 61/36; H01J 9/395; H01J 61/42; H01J 9/26; H01J 61/20; H01J 61/60

(52) U.S. Cl. CPC H01J 61/35; H01J 61/20; H01J 61/36; H01J 61/60; H01J 61/42; H01J 9/265; H01J 9/395

(57) ABSTRACT

Fluorescent lamps that utilize mercury, and methods and materials to reduce the solubility of mercury when fluorescent lamps are disposed of in a landfill. Such a fluorescent lamp includes a transparent envelope and at least one base enclosing an interior chamber within the envelope. The base has an interior surface and a sealing portion sealed to the envelope with a cement. A gas mixture comprising mercury vapor is contained within the interior chamber, and a quantity of material is disposed on the interior surface of the base. The quantity of material is spaced apart from the sealing portion and the cement thereof, and comprises a chemical agent that substantially reduces or prevents formation of leachable mercury.

### BACKGROUND OF THE INVENTION

The present invention generally relates to lighting systems and related technologies. More particularly, this invention relates to fluorescent lamps that utilize mercury, and to methods and materials to reduce the solubility of the mercury when the lamps are disposed of.

Fluorescent lamps have been in use and commercialization since the 1930s. More recently, fluorescent lamps have seen an increase in usage due to their increased energy efficiency as compared to conventional incandescent lights.

A nonlimiting example of a fluorescent lamp 10 is schematically represented in FIG. 1 as comprising a transparent (e.g., glass) envelope or shell 12 closed by a pair of oppositely-disposed bases (end caps) 20 to define a sealed interior chamber 14. The chamber 14 is preferably at very low pressure, for example, around 0.3% atmospheric pressure, and contains a gas mixture having at least one constituent that can be ionized to generate radiation that includes ultraviolet (UV) wavelengths. According to the current state of the art, such a gas mixture includes one or more inert gases (for example, argon) or a mixture of one or more inert gases and other gases at a low pressure, along with a small quantity of elemental mercury vapor, such that a lamp of the type represented in FIG. 1 is commonly referred to as a low pressure mercury-vapor gas-discharge lamp. Electrodes 16 inside the chamber 14 are electrically connected to electrical contact pins 18 that extend from the bases 20 of the lamp 10. When the contact pins 18 are connected to a power source, the applied voltage causes current to flow through the electrodes 16 and electrons to migrate from one electrode 16 to the other electrode 16 at the opposite end of the chamber 14. In the process, this energy converts a small amount of the liquid mercury from the liquid state to a charged (ionized) gaseous (vapor) state. The electrons and charged gas molecules move through the chamber 14, occasionally colliding with and exciting the gaseous mercury molecules, raising the energy level of the electrons in the mercury atoms. In order to return to their original energy level, the electrons release photons.

Due to the arrangement of electrons in mercury atoms, most of the photons released by these electrons are in the ultraviolet (UV) wavelengths. This is not visible light, and as such for the lamp 10 to emit visible light these photons must be converted to a visible light wavelength. Such a conversion can be performed by a coating 22 disposed at the interior surface of the shell 12. The coating 22 comprises phosphor powders and, as represented in FIG. 1, is typically separated from the shell 12 by a UV-reflecting barrier layer 24 of, for example, alumina (Al₂O₃). The UV wavelengths emitted by the ionized mercury vapor are absorbed by the phosphor composition within the coating 22, resulting in excitation of the phosphor composition to produce visible light that is emitted through the shell 12. While the following discussion will make reference to the lamp 10 represented in FIG. 1, it should be appreciated that the discussion will also pertain to other lamp types and configurations, for example, compact fluorescent lamps (CFLs).

It is well known that certain forms of mercury may seep or leach into surface and subsurface water if a product containing mercury, for example, the lamp 10 of FIG. 1, is discarded in a landfill. As used herein, leachability is a measure of the potential for such forms of mercury to seep or leach into groundwater if the product is landfill-disposed, and “leachable mercury” will be used herein to refer to such forms of mercury. In the U.S.A., the current maximum concentration level for mercury established by the Environmental Protection Agency (EPA) is 0.2 milligrams of leachable mercury per liter of extract fluid. The mercury concentration level is determined by a standard analysis known as the Toxicity Characteristic Leaching Procedure (TCLP).

From the above description, it should be understood that the lamp 10 comprises metallic components exposed within the chamber 14, for example, in the form of electrodes 16, contact pins 18, and bases 20, as well as other wiring. Whereas elemental (metallic) mercury is nonleachable, if elemental mercury within the chamber 14 comes in contact with certain metal components in the lamp 10, for example, those containing copper or iron, it may be transformed into one or more soluble, and therefore leachable, forms of mercury. Nonlimiting examples include mercurous and mercuric compounds resulting from the oxidation of metallic mercury. As a particular example, during operation of the lamp 10, the elemental mercury can be converted by free oxygen to a mercuric oxide (HgO) or a mercury salt that is water soluble. When the lamp 10 is landfill-disposed, its shell 12 is broken and pulverized and the leachable mercury compounds as well as the nonleachable elemental mercury of the lamp 10 are exposed to an aqueous environment. In addition to leaching of the mercury compounds, the exposed elemental mercury can oxidize to form one or more leachable mercury compounds as a result of the metal components of the lamp 10 providing a source of oxidizable iron or oxidizable copper.

Various techniques have been proposed and developed to inhibit the formation of leachable mercury compounds when a fluorescent lamp is landfill-disposed. Such techniques are often directed to incorporating a chemical agent, such as a compound or metal, into the construction of a lamp, for example, by placing the chemical agent in a glass capsule or within a basing cement that secures the shell to the bases of the lamp. Chemical agents proposed for this purpose are often antioxidants that serve to electrochemically reduce the leachable mercury compounds to elemental (metallic) mercury, and have included metal salts such as salts of silver, copper, iron, tin, and/or titanium (for example, silver carbonate and copper carbonate), salts such as bromide anions, chloride anions, iodide anions, iodate anions, periodate anions, and sulfide anions, and metal powders containing iron, copper, tin, and/or titanium. Other notable chemical agents include mercury antioxidants, for example, ascorbic acid, sodium ascorbate, and sodium gluconate, disclosed in U.S. Pat. No. 5,821,682. Chemical agents capable of reducing or preventing formation of leachable mercury by binding mercury in an insoluble form are also known and utilized in the lighting industry, nonlimiting examples of which include sulfur compounds that form insoluble mercury compounds such as mercury sulfide (HgS; cinnabar). The above-noted chemical agents, particularly ascorbic acid, silver carbonate, and copper carbonate, are often mixed with the basing cement with the intent that they will become at least partially available during the lamp disposal process (which includes pulverization) to minimize the leaching of soluble mercury into the land-fill soil.

Manufacturing methods and materials directed to the production of fluorescent lamps often take into consideration the desire to deliver an effective amount of the chemical agent, and such efforts can require modifications to lamp designs. It should be appreciated that there are ongoing efforts to promote the manufacturability of fluorescent lamps, while also maintaining or reducing the amount of leachable mercury that forms when such lamps are disposed of in a landfill in order to meet TCLP standards.

### BRIEF DESCRIPTION OF THE INVENTION

The present invention provides fluorescent lamps that utilize mercury, and methods and materials to reduce or prevent formation of leachable mercury when fluorescent lamps are disposed of in a landfill.

According to one aspect of the invention, a fluorescent lamp includes a transparent envelope and at least one base enclosing an interior chamber within the envelope. The base has an interior surface and a sealing portion sealed to the envelope with a cement and an interior surface. A gas mixture comprising mercury vapor is contained within the interior chamber, and a quantity of material is disposed on the interior surface of the base. The quantity of material is spaced apart from the sealing portion and the cement thereof, and comprises a chemical agent that substantially reduces or prevents formation of leachable mercury.

According to another aspect of the invention, a method is provided for inhibiting formation of leachable mercury compounds in a fluorescent lamp that contains elemental mercury within an interior chamber enclosed by a transparent envelope and at least one base. The method includes depositing a quantity of material on an interior surface of the base. The quantity of material is spaced apart from a sealing portion of the base. The quantity comprises a chemical agent that substantially reduces or prevents formation of leachable mercury. The transparent envelope is then sealed with the base so as to enclose the interior chamber within the envelope. The sealing portion of the base is sealed to the envelope with a cement and the quantity of material is spaced apart from the cement. A gas mixture comprising mercury vapor is then introduced into the interior chamber.

A technical effect of the invention is the ability to inhibit mercury leaching from disposed fluorescent lamps in a manner that can promote the availability of a chemical agent capable of reducing or preventing formation of leachable mercury, while also facilitating the manufacture of such lamps.

Other aspects and advantages of this invention will be better appreciated from the following detailed description.

### BRIEF DESCRIPTION OF THE DRAWINGS

FIG. 1 represents a fluorescent lamp, a fragmentary cross-sectional view of a tube of the lamp, and an inner surface of the tube provided with a coating system that includes a phosphor-containing coating.

FIG. 2 is a view depicting the interior of a base of a lamp of the type represented in FIG. 1.

### DETAILED DESCRIPTION OF THE INVENTION

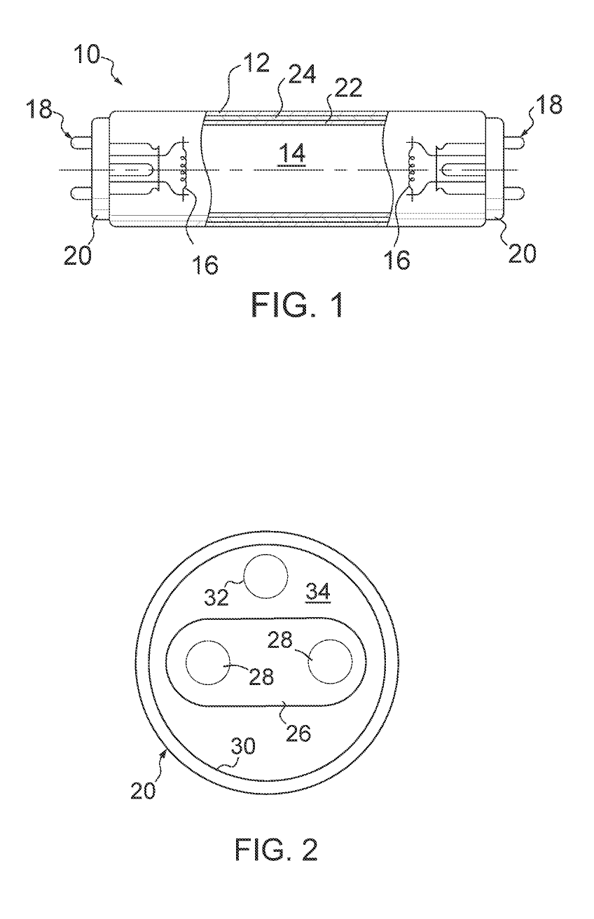

The invention will be described hereinafter in reference to the lamp 10 shown in FIG. 1, though it should be appreciated that the teachings of the invention are not limited to the lamp 10 and instead are more generally applicable to various lamp designs in which mercury may be present. It should also be noted that the drawings are drawn for purposes of clarity when viewed in combination with the following description, and therefore are not necessarily to scale.

FIG. 2 represents an interior view of one of the bases (end caps) 20 of the lamp 10 of FIG. 1. The base 20 may be representative of both or only one of the bases 20 in FIG. 1. Visible in FIG. 2 is an insulator 26 from which extends two leads 28 that are electrically connected to the contact pins 18 on the opposite side of the base 20, and in the final assembly of the lamp 10 are also electrically connected to the electrodes 16 within the transparent (e.g., glass) shell 12 of the lamp 10. With conventional lamp designs of the type represented in FIGS. 1 and 2, a basing cement (not shown) is placed along a sealing portion of the base 20, represented in FIG. 2 as the interior rim 30 of the base 20, for the purpose of bonding and sealing the base 20 to the transparent shell 12 of the lamp 10. Nonlimiting examples of basing cement formulations contain a marble flour (e.g., limestone (CaO)), shellac, phenolic resin binders, and solvents for blending. Furthermore, conventional practice would be to incorporate into the basing cement a chemical agent that is capable of reducing or preventing formation of leachable mercury, such that following disposal and pulverization of the lamp 10 the chemical agent becomes available to inhibit leaching of mercury into the landfill soil.

In contrast to conventional practice, the present invention provides a quantity 32 of material that comprises at least one chemical agent and is located on the base 20, but entirely separate from the basing cement located at the rim 30 of the base 20. As represented in FIG. 2, the quantity 32 is a film, layer or coating in the form of a circular-shaped “dot” that has been printed or otherwise deposited onto a region of an interior surface 34 of the base 20 that is entirely surrounded by a wall that defines the rim 30, such that the quantity 32 is enclosed within the chamber 14 of the assembled lamp 10 and exposed to the gas mixture within the chamber 14, but physically separate and spaced apart from the sealing portion (including the rim 30) of the base 20.

The composition of the chemical agent can be any material capable of reducing or preventing formation of leachable mercury, nonlimiting examples of which include chemical agents capable of electrochemically reducing a leachable mercury compound to nonleachable elemental (metallic) mercury, and chemical agents capable of binding mercury in an insoluble form. Nonlimiting examples of the former include metal salts such as silver carbonate, copper carbonate, manganese carbonate, stannic chloride, or any combination thereof, salts such as ascorbic acid, sodium ascorbate, sodium gluconate, bromide anions, chloride anions, iodide anions, iodate anions, periodate anions, sulfide anions, or any combination thereof, and metal powders such as iron-containing powders, copper-containing powders, tin-containing powders, titanium-containing powders, or any combination thereof. Nonlimiting examples of chemical agents capable of binding mercury in an insoluble form include sulfur compounds that form insoluble mercury compounds such as mercury sulfide. The chemical agent is preferably mixed with one or more binders to yield an ink that can promote printing and adhesion of the chemical agent to the surface 34 of the base 20. Because the quantity 32 containing the chemical agent is separate and spaced apart from the basing cement at the rim 30, the chemical agent does not interfere with the application or adhesion processes required of the cement. Furthermore, the chemical agent is separate and spaced apart from the leads 28 and insulator 26 of the base 20, and therefore located so as to prevent or at least reduce the likelihood of any interaction with the leads 28 and insulator 26. Applying or printing of the quantity 32 containing the chemical agent can be performed during manufacturing of the base 20 as a separate step using conventional precision application technologies. As such, placement of the chemical agent in a manner such as that represented in FIG. 2 can provide manufacturing advantages over existing methods involving blending of a chemical agent into the basing cement formulation.

To be effective, several milligrams of the chemical agent, for example, silver and/or copper carbonate, typically need to be present in conventional fluorescent lamps in order to achieve an acceptably low level of soluble mercury during a TCLP measurement process. Effective delivery of a chemical agent incorporated into a basing cement by extraction or dispersion of the chemical agent can be difficult to reliably accomplish, particularly if the basing cement contains such conventional ingredients as shellacs and rosins as taught by U.S. Pat. No. 5,821,682. Consequently, incorporating the chemical agent incorporated into the basing cement can result in high variability of measured TCLP results that is often addressed by the use of more of the chemical agent than might be otherwise necessary. In contrast, by placing the chemical agent as a quantity 32 physically and chemically separate and isolated from the basing cement at the rim 30, the embodiment of FIG. 2 is capable of providing a chemical agent that is more readily available for reducing or preventing formation of leachable mercury.

In addition to promoting printing and adhesion of the quantity 32 to the surface 34 of the base 20, a binder combined with the chemical agent can be chosen on the basis of enhancing, or at least not inhibiting, the water solubility of the chemical agent during TCLP measurement. In addition, the chemical agent and binder can be further combined with additives capable of enhancing, or at least not inhibiting, the water solubility of the chemical agent. Nonlimiting examples of suitable binders include synthetic binders such as polyethers (for example, polyethylene oxide), polyacrylates, and polyvinylalcohols, and natural water-soluble resins including types derived from cellulose, Nonlimiting examples of suitable additives include surfactants and wetting agents to promote the flow and application of the ink, as well as rheology stabilizers to promote stable application performance during production processing. During processing of the deposited ink containing the chemical agent, which may include heating the deposited ink to remove any solvents or other volatile constituents, such binders and additives may be at least partially removed prior to final assembly of the lamp 10, and the quantity 32 is likely to consist of the chemical agent, binder(s), and any remnants or residual portions of the optional additive(s). It is believed that the chemical agent should constitute, by volume, at least 0.01 percent of the quantity 32, more preferably about 0.1 to about 10 percent of the quantity 32, with the balance of the quantity 32 being binder(s) and any optional additives. The total amount of binder(s) in the quantity 32 is, by volume, at least 10 percent and not more than 99.9 percent of the quantity 32, more preferably about 20 to about 60 percent of the quantity 32. One or more of the above-noted additives may constitute any remaining portion of the quantity 32, and the amount of any such additives in the quantity 32 may be, by volume, up to about 60 percent of the quantity 32, and in certain embodiments about 28 to about 30 percent of the quantity 32. Notably, selection of such binders and additives and their amounts can be without concern for adverse effects on the basing cement, and avoids complications of cement preparation and use that might otherwise occur on a production line where different types of lamps are being manufactured, some of which may not contain mercury and therefore are not required to meet TCLP compliance standards.

Though the quantity 32 is represented as being a circular-shaped dot, other shapes are within the scope of the invention. Dispensing of the ink that will form the quantity 32 on the base surface 34 can be achieved with precise application technologies that enable the volume of the quantity 32 to be well controlled, with the result that the amount of potentially expensive chemical agent can also be well controlled. Moreover, by placing the chemical agent in a binder and optional additives that do not inhibit the extraction or dispersion of the chemical agent from the quantity 32 to the same extent that basing cements may, lesser amounts of the chemical agent may be used in the lamp 10 while still meeting TCLP compliance. The chemical agent must be present within the lamp 10 in an effective amount to substantially reduce or prevent formation of leachable mercury, for example, in order to meet TCLP standards, currently 0.2 milligrams of leachable mercury per liter of extract fluid. On this basis, it is believed that the total amount of chemical agent provided by the quantity 32 should be at least 0.01 milligram, more preferably about 0.35 to about 3.0 milligrams for a fluorescent lamp of the type represented in FIG. 1.

While the invention has been described in terms of specific embodiments it is apparent that other forms could be adopted by one skilled in the art. Therefore, the scope of the invention is to be limited only by the following claims.

1. A fluorescent lamp comprising:
a transparent envelope;
at least one base enclosing an interior chamber within the envelope, the base having an interior surface within the interior chamber and a sealing portion sealed to the envelope with a cement;
a gas mixture within the interior chamber, the gas mixture comprising mercury vapor; and
a quantity of material on the interior surface of the base, the quantity of material being spaced apart from the sealing portion and the cement thereof, the quantity of material comprising a chemical agent that substantially reduces or prevents formation of leachable mercury.

2. The fluorescent lamp according to claim 1, wherein the envelope is a tube.

3. The fluorescent lamp according to claim 1, wherein the chemical agent electrochemically reduces at least one form of leachable mercury to metallic mercury.

4. The fluorescent lamp according to claim 1, wherein the quantity of material contains at least 0.1 milligram of the chemical agent and the chemical agent constitutes, by volume, at least 0.01 percent of the quantity of material.

5. The fluorescent lamp according to claim 1, wherein the chemical agent constitutes, by volume, about 0.1 to about 10 percent of the quantity of material, with the balance of the quantity of material being one or more of binders and/or additives.

6. The fluorescent lamp according to claim 1, wherein the quantity of material further comprises a binder.

7. The fluorescent lamp according to claim 6, wherein the binder does not inhibit the water solubility of the chemical agent.

8. The fluorescent lamp according to claim 7, wherein the binder is chosen from the group consisting of water-soluble synthetic binders and water-soluble resins derived from cellulose.

9. The fluorescent lamp according to claim 7, wherein the binder constitutes, by volume, at least 10 percent of the quantity of material.

10. The fluorescent lamp according to claim 7, wherein the binder constitutes, by volume, about 20 to about 60 percent of the quantity of material, with the balance of the quantity of material being the chemical agent and optionally one or more additives.

11. The fluorescent lamp according to claim 1, wherein the quantity of material further comprises at least one additive that does not inhibit the water solubility of the chemical agent.

12. The fluorescent lamp according to claim 11, wherein the at least one additive is chosen from the group consisting of surfactants, wetting agents, and rheology stabilizers.

13. The fluorescent lamp according to claim 11, wherein the at least one additive constitutes, by volume, up to 60 percent of the quantity of material, with the balance of the quantity of material being the chemical agent and at least one binder.

14. A method for inhibiting formation of leachable mercury compounds in a fluorescent lamp that contains elemental mercury, the method comprising:
providing a quantity of material on an interior surface of at least one base, the quantity of material being spaced apart from a sealing portion of the base, the quantity of material comprising a chemical agent that substantially reduces or prevents formation of leachable mercury;
sealing a transparent envelope with the base so as to enclose an interior chamber within the envelope, the sealing portion of the base being sealed to the envelope with a cement and the quantity of material being spaced apart from the cement; and
introducing into the interior chamber a gas mixture comprising mercury vapor.

15. The method according to claim 14, wherein the chemical agent electrochemically reduces at least one form of leachable mercury to metallic mercury.

16. The method according to claim 14, wherein the quantity of material contains at least 0.1 milligram of the chemical agent and the chemical agent constitutes, by volume, at least 0.01 percent of the quantity of material.

17. The method according to claim 14, wherein the quantity of material further comprises a binder.

18. The method according to claim 17, wherein the binder does not inhibit the water solubility of the chemical agent.

19. The method according to claim 18, wherein the binder is chosen from the group consisting of water-soluble synthetic binders and water-soluble resins derived from cellulose.

20. The method according to claim 14, wherein the quantity of material further comprises at least one additive that does not inhibit the water solubility of the chemical agent.
